(19) United States
(12) Patent Application Publication
(10) Pub. No.: US 2003/0081907 A1
(43) Pub. Date: May 1, 2003

(54) Device for blocking emitted light

(75) Inventors: Gerald Daniel Malagrino JR., Rochester, MN (US); Roderick John Raver, Rochester, MN (US)

Correspondence Address: Robert H. Berdo, Jr., RABIN & BERDO, P.C., Suite 500, 1101 14th Street, N.W., Washington, DC, 20005, US

(73) Assignee: INTERNATIONAL BUSINESS MACHINES CORPORATION, ARMONK, NY

(21) Appl. No.: 09/984,301

(22) Filed: Oct. 29, 2001

(51) Int. Cl. G02B 6/38; G02B 6/35; G02B 6/42

(52) U.S. Cl. 385/73; 385/19

(57) ABSTRACT

A light blocking device for an optical transmitter includes a flap (46) that is movable to a first position in which light is allowed to pass unhindered from a laser (18), and is movable to a second position to block the light emitted from the laser. The light blocking device further includes a panel member (48) connectable to a housing (10) of the optical transmitter. The flap (46) is connected to an edge of the panel member (48).

### CROSS REFERENCE TO RELATED APPLICATIONS

The subject matter of this application is related to the disclosures contained within U.S. patent application Ser. No. ______, attorney docket no. ROC920010219US1-IBM-213, entitled Integrated Optical Coupler and Housing Arrangement, and filed on Oct. 5, 2001; within U.S. patent application Ser. No. 09/894,934, attorney docket no. ROC920010154US1-IBM-212, entitled Enhanced Optical Transceiver Arrangement, and filed on Jun. 28, 2001; within U.S. patent application Ser. No. 09/894,714, attorney docket no. ROC920010151US1-IBM-210, entitled Enhanced Optical Coupler, and filed on Jun. 28, 2001; and within U.S. patent application Ser. No. 09/893,812, attorney docket no. ROC92001118US1, entitled A Processing Protective Plug Insert for Optical Modules, and filed on Jun. 28, 2001, all having been assigned to International Business Machines, Corporation.

### BACKGROUND OF THE INVENTION

1. Field of the Invention

The present invention relates to a device for blocking emitted light, and in particular, to an opaque flap that covers a fiber optic cable opening of an optical transmitter when a fiber optic cable is not present within the opening, to prevent light from being emitted from the optical transmitter into the environment.

2. Background Information

Computer and communication systems are now being developed in which optical devices, such as fiber optic cables, are used as a conduit (also known as a wave guide) for modulated light waves to transmit information. These systems typically include an optical transmitter that has a light emitter, or an optical receiver that has a light detector. A typical light emitter may be a laser, such as a vertical cavity surface emitting laser (VCSEL). A typical light detector may be a photodiode. A generic term of either an optical transmitter or a optical receiver is an “optoelectronic transducer.” The fiber optic cable is typically coupled to the respective light detector or light emitter, so that optical signals can be transmitted back and forth, for example.

As an example, optoelectronic transducers convert electrical signals to or from the optical signals; the optical signals carry data to the light detector from the light emitter via the fiber optic cable at very high speeds. Typically, the optical signals are converted into, or converted from, the associated electrical signals using known circuitry. Such optoelectronic transducers are often used in devices, such as computers, in which data must be transmitted at high rates of speed.

In order to provide for higher speed signal transmissions (for instance 1 Gb/s), the light emitter, for example the laser, needs to be operated at a higher power. This can be accomplished by coupling the laser to a laser driver, and then delivering a relatively high voltage to the laser.

However, there are environmental and safety concerns that prohibit operating the laser at any selected power. For example, if there is a possibility that the laser light may be transmitted into the ambient environment, it must be ensured that the transmitted light will not cause an injury, if for example, the light should impinge on an eye of a user or passerby. To help reduce the chance of such injury occurring, the Center for Devices and Radiological Health (CDRH) has provided laser safety limits, which stipulate a maximum power a laser may be operated at. Generally, the greater the risk that the laser light may be transmitted into the ambient environment, the lower the laser safety limits are.

With the conventional laser light emitter, should the fiber optic cable inadvertently become disconnected from the light emitter while in operation, there is a high risk that the laser light will be emitted into the ambient environment. Thus, the laser safety limits for the conventional laser light emitter are relatively low. These low safety limits significantly impede the development of optoelectronic transducers having a very high speed.

Nevertheless, developers have been able to exceed the CDRH laser safety limits by applying for variances. Although variances are often granted, there are still several concerns. For example, there is some uncertainty by the developers and manufacturers of the optoelectronic transducers as to whether a variance will ultimately be granted. The risk and uncertainty of whether the variance will be granted increases as the output power requirements of the light emitter exceeds the safety limits. That is, it is more likely that a variance will not be granted for a laser light emitter that significantly exceeds the safety limits than for a laser that only slightly exceeds the safety limits. Moreover, applying for a variance is time consuming, and may impede the development process. Furthermore, if the variance is not granted, then the optoelectronic transducer will need to be redesigned using a lower power. Additionally, even if the variance is granted, there is a possibility that the light emitter will be prohibited from being used or sold in foreign countries, for exceeding the foreign country's own safety limits. Moreover, the granting of a variance does not reduce the risk of injury to a user or passerby, should the fiber optic cable inadvertently become disconnected from the light emitter while in operation. To the contrary, the risk of injury is increased, since the power of the light emitter will be exceeding the designated safety limits.

Thus, there is a need for an optoelectronic transducer that can be operated at a high power output without requiring safety limit variances. There is a further need for an optoelectronic transducer that can be safely operated at any desired power level. Further, there is a need for a safety device that can be used on a conventional optoelectronic transducer, that allows the optoelectronic transducer to be safely operated at any desired power level, and without applying for a safety limit variance.

### SUMMARY OF THE INVENTION

It is, therefore, a principal object of this invention to provide a device for blocking emitted light.

It is another object of the invention to provide a device for blocking emitted light that solves the above mentioned problems.

These and other objects of the present invention are accomplished by the device for blocking emitted light disclosed herein.

According to one aspect of the invention, a device is provided that can be used with a light emitter, such as those used within optical transmitters, for blocking light emitted from the light emitter from entering the ambient environment. In an exemplary aspect of the invention, the light emitter is a laser, such as a vertical cavity surface emitting laser (VCSEL). Moreover, in an exemplary aspect of the invention, the optical transmitter includes a housing, which has a recess for receiving a fiber optic connector. However, the concepts of the present invention may be used with any light emitter and/or any optical transmitter, without departing from the spirit and scope of the present invention.

To reduce the risk of light, such as laser light for example, from inadvertently entering the ambient environment, in an exemplary aspect of the invention, the light blocking device is adapted to at least partially cover an opening of the recess when the fiber optic connector is removed. Thus, the light emitted from the laser will impinge upon the light blocking device, and will be prevented from escaping into the ambient environment.

In a further exemplary aspect of the invention, the light blocking device has an opaque flap that is disposed in the recess when the fiber optic connector is received within the recess, and which automatically moves to a position in which the flap at least partially covers the recess when the fiber optic connecter is removed. In this aspect of the invention, when the fiber optic connecter is inserted within the recess, the fiber optic connector pushes the flap to a side of the recess, and out of the way, to allow the fiber optic connector to be coupled to the housing. For example, the flap can be pushed toward a top of the recess. Alternatively, it is also contemplated that the flap could be pushed to the lateral sides or the bottom of the recess.

In another exemplary aspect of the invention, the light blocking device further includes a thin panel member, to which the flap is joined. The panel member may be connected to the housing, for example the upper outer surface of the housing, and arranged so that the flap is disposed over the opening of the recess, when there is no fiber optic connector attached thereto. For example, in one aspect of the invention, the panel member may be adhered to the upper surface of the housing portion. With such an arrangement, the panel member may also serve as a label, and be provided with information data regarding the transceiver. Alternatively, or in combination to the adhesive, a conductive EMI shield may be disposed over the panel member to help hold the panel member against the surface of the housing portion.

In a further exemplary aspect of the invention, the flap is integrally formed with the panel member. This allows the flap and panel member to be molded, for example, to have a predefined configuration. Moreover, the resulting device will have a memory effect that will help to retain the flap and panel member in this predefined configuration, when no other forces are present. By way of example, the flap may be arranged to be essentially perpendicular to the panel member. The term “essentially perpendicular” is understood to mean that the flap, for example, is arranged in a generally vertical direction, whereas the panel member is arranged in a generally horizontal position. Thus, when the panel member is attached to the surface of the housing, the flap will project over the opening of the recess. When the fiber optic connector is inserted into the recess, the fiber optic connector will push the flap toward a side of the recess, so that the flap and the panel member will be essentially parallel to each other. When the fiber optic connector is removed from the recess, the memory effect of the flap and panel member will cause the flap to automatically move back to its natural position, which in the exemplary embodiment is essentially perpendicular to the panel member.

It is contemplated that other configurations of the flap and panel member are possible within the spirit and scope of the invention. For example, the flap may be separately hinged to the panel member. With this arrangement, gravity could be used to move the flap to a position in which the opening of the recess is covered. Of course, this would require a redefined arrangement of the optical transmitter. Alternatively, a spring could be provided to move the flap to the position in which the opening of the recess is covered. However, this aspect of the invention requires more parts, and would increase assembly time.

It is also contemplated that the flap be directly joined, either integrally or using a separate hinge, to the housing, so that the panel member could be eliminated. However, it is currently believed that the use of the panel member facilitates assembly. Moreover, when a panel member is provided, the light blocking device can be easily adapted for use with conventional optical transceivers.

In the above described exemplary embodiments, the flap and panel member are formed from a mylar/polymide material. This material can provide the desired light blocking capability, and provide the desired memory effect discussed above. However, the flap and/or the panel member may be formed of other materials without departing from the spirit and scope of the invention.

Further, although in the above-described exemplary embodiments one flap projects down from the upper surface of the housing, it is contemplated that the flap can project from any of the surfaces of the housing. Moreover, it is further contemplated that more than one flap may be provided. For example, one flap could be provided at the top of the recess opening, and another flap could be provided at the bottom of the recess opening. This configuration may be advantageous when one flap alone does not adequately cover the recess opening.

### BRIEF DESCRIPTION OF THE DRAWINGS

FIG. 1 is a rear perspective view of an exemplary optical transceiver that could be used with the light blocking device of the present invention.

FIG. 2 is a side sectional view of the optical transceiver shown in FIG. 1.

FIG. 3 is a perspective view of the optical transceiver shown in FIG. 1, being disposed within a computer, and having a heat sink, wiring board, and the EMI shield shown in FIG. 3 attached thereto, and being used with the light blocking device according to an exemplary aspect of the invention.

FIG. 4 is a perspective view of an EMI shield that may be used with the optical transceiver shown in FIG. 1.

FIG. 5 is a partial front view of the arrangement shown in FIG. 3.

FIG. 6 is a partial side sectional view of the arrangement shown in FIG. 3.

FIG. 7 is an enlarged partial sectional view, taken from section VII shown in FIG. 6.

FIG. 8 is a perspective view of the light blocking device according to an exemplary aspect of the invention.

FIG. 9 is a perspective view of an alternative exemplary optical transceiver, being used with the light blocking device according to an exemplary aspect of the invention, and having a heat sink and wiring board connected thereto.

### DETAILED DESCRIPTION OF THE PREFERRED EMBODIMENTS

The invention will now be described in more detail by way of example with reference to the embodiments shown in the accompanying figures. It should be kept in mind that the following described embodiments are only presented by way of example and should not be construed as limiting the inventive concept to any particular physical configuration.

Further, in the application, the terms “upper”, “lower”, “front”, “back”, “over”, “under”, “horizontal”, “vertical”, and similar such terms are not to be construed as limiting the invention to a particular orientation. Instead, these terms are used only on a relative basis.

The present invention is directed toward a device that can be used with a light emitter, such as those used within optical transmitters, for blocking light emitted from the light emitter from entering the ambient environment. In an exemplary aspect of the invention, the light emitter is a laser, such as a vertical cavity surface emitting laser (VCSEL). Further, the optical transmitter can be of the type disclosed in corresponding U.S. patent application Ser. No. ______, attorney docket no. ROC920010219US1-IBM-213, entitled Integrated Optical Coupler and Housing Arrangement, and Ser. No. 09/894,934, attorney docket no. ROC920010154US1-IBM-212, entitled Enhanced Optical Transceiver Arrangement, both having been assigned to International Business Machines, Corporation. However, the concepts of the present invention may be used with any optical transmitter, and/or any light emitter, without departing from the spirit and scope of the present invention.

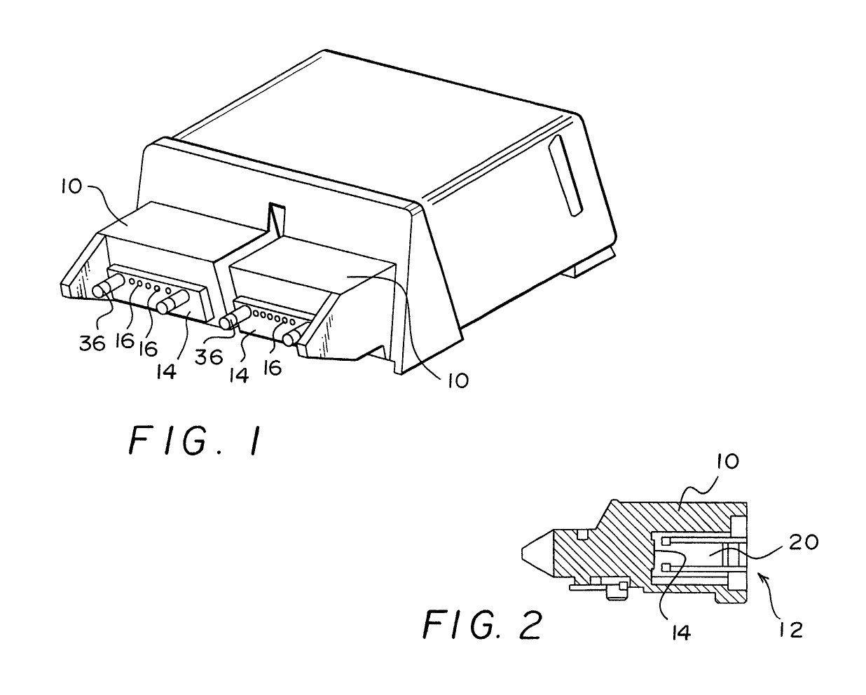

Briefly, and referring to FIGS. 1 and 2, this exemplary optical transmitter includes a housing 10 that has a recess 12 for selectively receiving either an industry standard MPO or MTP fiber optic connector (not shown), for example. As is conventional, the fiber optic connector will be disposed at an end of a fiber optic cable.

A back surface of the recess 12 is defined by an end surface of an optical coupler 14. The optical coupler 14 may be an integral feature of the housing 10 as shown, or may be a separate component that is attached to the housing 10. Further, the optical coupler 14 has a plurality of spaced apart optical fibers 16, each of which extends from one end surface of the optical coupler 14 to the other end surface. When the fiber optic connector is received within the recess 12, the optical fibers 16 of the optical coupler 14 will be positioned adjacent to the fiber optic connector. The optical fibers 16 of the optical coupler 14 are used to transmit optical signals between the optical fibers of the fiber optic cable and active regions of a light emitter 18, such as a VCSEL (see FIG. 7).

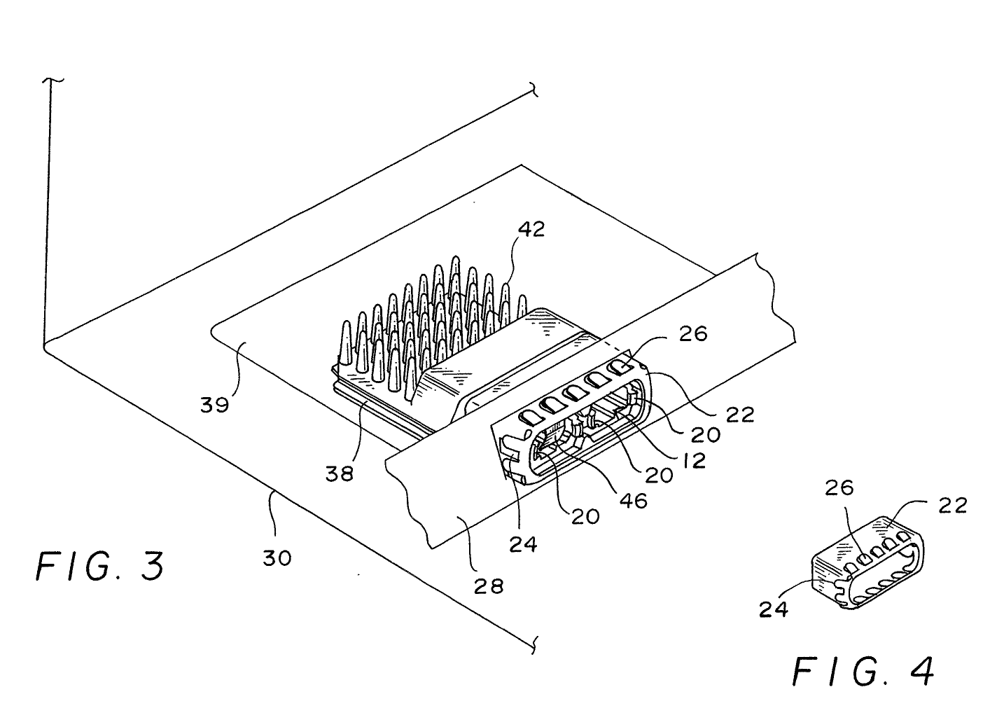

Referring also to FIG. 3, the housing 10 may be provided with a pair of latching fingers 20 disposed on opposite sides of the recess 12. The latching fingers 20 are adapted to engage with the fiber optic connector, to hold the connector within the recess 12.

If desired, first and second housings 10 may be disposed side-by-side, each of which contains an optical coupler 14. This configuration allows both a light emitter and a light detector, for example, to be disposed in the same assembly, therefore saving circuit board space. The respective housings can be manufactured separately and joined together, for example, or the two housings can be integrally molded together.

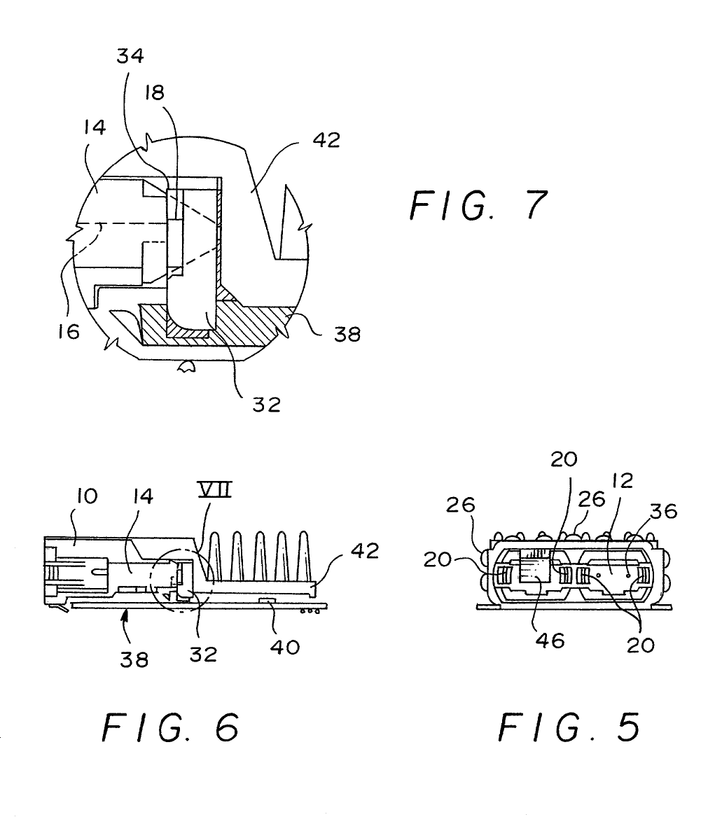

Referring also to FIGS. 4 and 5, the front end of the housing 10 may also be provided with an electromagnetic interference shield 22. The electromagnetic interference shield 22 is preferably formed from a conductive, non-corrosive material, such as steel having a tin plating. However, the electromagnetic interference shield 22 can be formed of any material that will attenuate electromagnetic interference.

As shown, the electromagnetic interference shield 22 is hollow, to allow the shield to be slipped over the front end of the housing 10. When properly positioned, the edge of the electromagnetic interference shield 22 will be positioned essentially flush with the front end of the housing 10. The shield 22 may be provided with inwardly projecting fingers 24 that engage with the surface of the housing 10, to hold the shield in place.

The electromagnetic interference shield 22 may be provided with a number of conductive grounding springs 26, which are disposed around the outer periphery of an end of the shield. The grounding springs 26 engage, for example, with a tailstock 28 attached to a system frame 30 of a computer, for example, to conductively couple the electromagnetic interference shield 22 to a ground potential. When properly positioned, the grounding springs 26 hold the electromagnetic interference shield 22 in a fixed position relative to the tailstock 28.

By way of example, the grounding springs 26 can be formed as metal fingers which initially extend in the same plane, and contiguous with, a respective wall of the shield 22. The metal fingers can then be bent so that the fingers are disposed at an angle relative to the respective walls they are attached to. Due to the memory effect of the material, the fingers will then exert a spring force that acts in a direction away from the walls. Thus, the metal fingers can engage with the tailstock, in the aforementioned manner.

The shield 22 can be used to hold the first and second housings together, when two separate housings are provided. That is, the shield 22 can be slid around the adjacent housings 10, and serve as a clamp to retain the housings in their relative positions.

Referring also to FIGS. 6 and 7, the exemplary optical transmitter further includes a die carrier 32, having opposing lands 34 (only one being shown in the side view of FIGS. 6 and 7). The opposing lands 34 have a receiving space therebetween, in which the light emitter 18 is disposed.

The carrier 32 may be manufactured from a conductive material, so that it can serve as a ground for the light emitter 18. For example, the carrier 32 can be formed from copper, and be gold plated to enhance its conductivity and reduce its susceptibility to oxidation. However, it is contemplated that the carrier 32 can be manufactured from other materials without departing from the spirit and scope of the invention.

The lands 34 are adapted to allow the optical coupler 14 to be attached thereto. For example, each land 34 can be provided with a receiving and alignment hole (not shown). Further, the end surface of the optical coupler 14 may have an alignment pin 36 or pins that projects therefrom (see FIG. 1). In the illustrated exemplary embodiment, the alignment pins 36 are disposed to flank the optical fibers 16. The alignment pins 36 are received within corresponding receiving and alignment holes in the lands 34, to align and fix the optical coupler 14 to the die carrier 32. Similarly, the other end surface of the optical coupler 14 may be provided with alignment pins 36 (see FIG. 5) which are insertable within corresponding holes formed in the fiber optic connector, to align and fix the optical coupler to the fiber optic connector.

The lands 34 may be adapted to project out slightly beyond the light emitter 18. This configuration prevents the optical coupler 14 from having direct contact with the active regions (i.e., the regions that emit the light) of the light emitter 18.

The housing 10 and die carrier 32 may be disposed on a wiring board 38, which may have electronic circuitry and devices 40 for controlling the light emitter 18. This wiring board 38 may then be electrically coupled to a mother board 39, for example, of the computer shown in FIG. 3. Moreover, a heat sink 42 may be provided over the housing 10, die carrier 32 and wiring board 38 to help dissipate any generated heat.

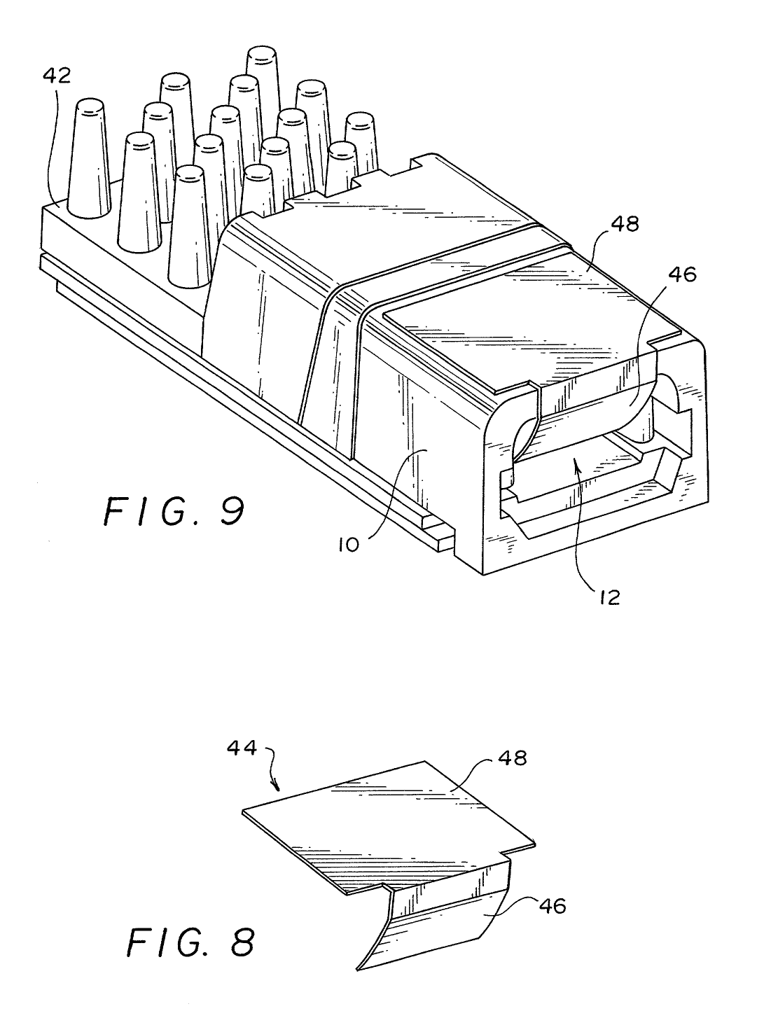

With the above described optical transmitter, if the fiber optic connector is removed from the recess 12 while the optical transmitter is operating, light emitted from the active regions of the light emitter 18 may enter the ambient environment. As previously discussed, if the light emitter 18 is a laser, this could be particularly disadvantageous. Referring also to FIGS. 8 and 9, to reduce the risk of this occurring, in an exemplary aspect of the invention, a light blocking device 44 is provided that at least partially covers the opening into the recess 12 when the fiber optic connector is removed. Thus, the light emitted from the laser will impinge upon the light blocking device 44, and will be prevented from escaping into the ambient environment.

In one exemplary aspect of the invention, the light blocking device 44 has an opaque flap 46 that is disposed in the recess when the fiber optic connector is received within the recess, and which automatically moves to a position in which the flap at least partially covers the recess when the fiber optic connecter is removed. In this aspect of the invention, when the fiber optic connecter is inserted within the recess 12, the fiber optic connector pushes the flap 46 to the side of the recess, and out of the way, to allow the fiber optic connector to be coupled to the housing 10 in the aforedescribed manner. For example, the flap 46 can be pushed toward a top of the recess 12 as shown. Alternatively, it is also contemplated that the flap 46 could be pushed to the lateral sides or the bottom of the recess 12.

In the illustrated exemplary embodiment, the light blocking device 44 further includes a thin panel member 48, to which the flap 46 is joined. The panel member 48 may be connected to the housing 10, for example the upper outer surface of the housing, and arranged so that the flap 46 is disposed over the opening of the recess 12, when there is no fiber optic connector attached thereto. For example, in one aspect of the invention, the panel member 48 may be adhered to the upper surface of the housing 10. With such an arrangement, the panel member 48 may also serve as a label, and be provided with information data regarding the transceiver. Alternatively, or in combination to the adhesive, the conductive shield 22 may be disposed over the panel member 48 to help hold the panel member against the surface of the housing 10.

In a further exemplary aspect of the invention, the flap 46 is integrally formed with the panel member 48. This allows the flap 46 and panel member 48 to be molded, for example, to have a predefined configuration. Moreover, the resulting device will have a memory effect that will help to retain the flap 46 and panel member 48 in this predefined configuration, when no other forces are present. By way of example, this predefined configuration may have the flap 46 arranged to be essentially perpendicular to the panel member 48. The term “essentially perpendicular” is understood to mean that the flap 46, for example, is arranged in a generally vertical direction, whereas the panel member 48 is arranged in a generally horizontal position. Thus, when the panel member 48 is attached to the surface of the housing 10, the flap 46 will project over the opening of the recess 12. When the fiber optic connector is inserted into the recess 12, the fiber optic connector will push the flap 46 out of the way and toward a side of the recess, so that the flap and the panel member 48 will be essentially parallel to each other. When the fiber optic connector is removed from the recess, the memory effect of the flap 46 and panel member 48 will cause the flap to automatically move back to its natural position (i.e., the predefined configuration), which in the exemplary embodiment is essentially perpendicular to the panel member.

It is contemplated that other configurations of the flap 46 and panel member 48 are possible within the spirit and scope of the invention. For example, the flap 46 may be separately hinged to the panel member 48. With this arrangement, gravity could be used to move the flap 46 to a position in which the opening of the recess 12 is covered. Of course, this would require a redefined arrangement of the optical transmitter, in order to ensure gravity will move the flap to the desired position. Alternatively, a spring could be provided to move the flap 46 to the position in which the opening of the recess 12 is covered. However, this aspect of the invention requires more parts, and would increase assembly time.

It is also contemplated that the flap 46 be directly joined, either integrally or using a separate hinge, to the housing 10, so that the panel member 48 could be eliminated. However, it is currently believed that the use of the panel member 48 facilitates assembly. Moreover, when a panel member is provided, the light blocking device can be easily adapted for use with conventional optical transceivers.

In the above described exemplary embodiments, the flap 46 and panel member 48 are formed from a mylar/polymide material. This material can provide the desired light blocking capability, and provide the desired memory effect discussed above. However, the flap and/or the panel member may be formed from other materials without departing from the spirit and scope of the invention.

Further, although in the above-described exemplary embodiments one flap projects down from the upper surface of the housing, it is contemplated that the flap can project from any of the surfaces of the housing. Moreover, it is further contemplated that more than one flap may be provided. For example, one flap could be provided at the top of the recess opening, and another flap could be provided at the bottom of the recess opening. This configuration may be advantageous when one flap alone does not adequately cover the recess opening.

It should be understood, however, that the invention is not necessarily limited to the specific arrangement and components shown and described above, but may be susceptible to numerous variations within the scope of the invention.

It will be apparent to one skilled in the art that the manner of making and using the claimed invention has been adequately disclosed in the above-written description of the preferred embodiments taken together with the drawings.

It will be understood that the above description of the preferred embodiments of the present invention are susceptible to various modifications, changes, and adaptations, and the same are intended to be comprehended within the meaning and range of equivalents of the appended claims.

What is claimed is:

1. A light blocking device, comprising:
a flap that is movable to a first position in which light is allowed to pass unhindered from a light emitter, and is movable to a second position to block the light emitted from the light emitter.

2. The light blocking device recited in claim 1, wherein said flap is automatically movable to the second position.

3. The light blocking device recited in claim 1, further comprising a panel member, said flap being connected to an edge of said panel member.

4. The light blocking device recited in claim 3, wherein when said flap is in the first position, said flap is essentially parallel to said panel member, and when said flap is in the second position, said flap is at an angle relative to said panel member.

5. The light blocking device recited in claim 3, wherein said flap is integrally formed with said panel member into an angled position, and wherein when said flap is in the second position, said flap and said panel member are in the angled position.

6. The light blocking device recited in claim 5, wherein said flap and said panel member have a memory effect to automatically return said flap to the second position from the first position.

7. The light blocking device recited in claim 1, wherein said flap is opaque.

8. The light blocking device recited in claim 1, wherein said flap is formed from a mylar/polymide material.

9. The light blocking device recited in claim 1, further comprising a panel member, said flap being connected to an edge of said panel member;
wherein said flap is integrally formed with said panel member into an angled position;
wherein when said flap is in the second position, said flap and said panel member are in the angled position;
wherein when said flap is in the first position, said flap is essentially parallel to said panel member;
wherein said flap and said panel member have a memory effect to automatically return said flap to the second position from the first position; wherein said flap is opaque; and
wherein said flap and said panel member are formed from a mylar/polymide material.

10. The light blocking device recited in claim 9, wherein when said flap is in the second position, said flap is essentially perpendicular to said panel member.

11. In combination,
an optical transmitter having a light emitter; and
light blocking device, comprising:
a flap that is movable to a first position in which light is allowed to pass unhindered from said light emitter, and is movable to a second position to block the light emitted from said light emitter.

12. The combination recited in claim 11, wherein said optical transmitter further includes a housing having a recess adapted to receive a fiber optic connector; and wherein said light emitter is a laser that emits the light for receipt by the fiber optic connector.

13. The combination recited in claim 12, wherein when said flap is in the second position, said flap at least partially covers an opening into the recess.

14. The combination recited in claim 13, wherein said flap is movable into the first position by receipt of the fiber optic connector into the recess.

15. The combination recited in claim 14, wherein said light blocking device further comprises a panel member connectable to said housing, said flap being connected to an edge of said panel member.

16. The combination recited in claim 15, wherein when said flap is in the first position, said flap is essentially parallel to said panel member, and when said flap is in the second position, said flap is at an angle relative to said panel member.

17. The combination recited in claim 15, wherein said flap is integrally formed with said panel member into an angled position, and wherein when said flap is in the second position, said flap and said panel member are in the angled position.

18. The combination recited in claim 17, wherein said flap and said panel member have a memory effect to automatically return said flap to the second position from the first position.

19. The combination recited in claim 12, wherein said light blocking device further includes a panel member connectable to an exterior portion of said housing, said flap being connected to an edge of said panel member; wherein when said flap is in the second position, said flap at least partially covers an opening into the recess; and wherein said flap is movable into the first position by receipt of the fiber optic connector into the recess.

20. The combination recited in claim 19, wherein said optical transmitter further comprises an EMI shield that is positionable around the exterior portion of said housing to connect and retain said panel member to the exterior portion.

21. The combination recited in claim 11, wherein said flap is opaque.

22. The combination recited in claim 11, wherein said flap is formed from a mylar/polymide material.

23. A computer, comprising:
a frame;
a circuit board disposed within said frame;
an optical transmitter disposed on said circuit board, and including:
a housing having a recess adapted to receive a fiber optic connector;
a laser that emits light for receipt by the fiber optic connector; and
an optical coupler disposed within said housing and being adapted to transmit the light emitted from said laser to the fiber optic connector; and
a light blocking device, comprising:
a flap that is movable to a first position in which the light is allowed to pass unhindered from said laser, and is movable to a second position to block the light emitted from said laser; and
a panel member connectable to said housing, said flap being connected to an edge of said panel member.

24. The computer recited in claim 23, wherein when said flap is in the second position, said flap at least partially covers an opening into the recess.

25. The computer recited in claim 23, wherein said flap is movable into the first position by receipt of the fiber optic connector into the recess.

26. The computer recited in claim 25, wherein when said flap is in the first position, said flap is essentially parallel to said panel member, and when said flap is in the second position, said flap is at an angle relative to said panel member.

27. The computer recited in claim 25, wherein said flap is integrally formed with said panel member into an angled position, and wherein when said flap is in the second position, said flap and said panel member are in the angled position.

28. The computer recited in claim 27, wherein said flap and said panel member have a memory effect to automatically return said flap to the second position from the first position.

29. The computer recited in claim 23, wherein said panel member is connectable to an exterior portion of said housing; wherein when said flap is in the second position, said flap at least partially covers an opening into the recess; and wherein said flap is movable into the first position by receipt of the fiber optic connector into the recess.

30. The computer recited in claim 23, wherein said optical transmitter further comprises an EMI shield that is positionable around an exterior portion of said housing to connect and retain said panel member to the exterior portion.
